(19) United States
(12) Patent Application Publication
(10) Pub. No.: US 2011/0038288 A1
(43) Pub. Date: Feb. 17, 2011

(54) MOBILE AUTOMATIC METER READING SYSTEM AND METHOD

(75) Inventors: Christopher Osterloh, Waseca, MN (US); Neil Hovelsrud, Waseca, MN (US); Gary L. Larson, Waseca, MN (US)

Correspondence Address: DORITY & MANNING, P.A. and ITRON, INC, POST OFFICE BOX 1449, GREENVILLE, SC, 29602, US

(73) Assignee: ITRON, INC., Liberty Lake, WA (US)

(21) Appl. No.: 12/912,358

(22) Filed: Oct. 26, 2010

Related U.S. Application Data
(62) Division of application No. 11/115,068, filed on Apr. 26, 2005.
(60) Provisional application No. 60/565,288, filed on Apr. 26, 2004.

(51) Int. Cl. H04B 7/00

(52) U.S. Cl. 370/310

(57) ABSTRACT

A system and method for collecting data generated by a plurality of metering devices located within a geographic area. The mobile automatic meter reading system provides two-way simplex communication capabilities between a mobile receiving device and a plurality of endpoint devices on a plurality of communication channels. The mobile collector device efficiently and accurately communicates with and receives data from the endpoint devices while moving throughout a localized geographical area. Aspects of the invention thereby improve the effectiveness of automatic meter reading systems.

### RELATED APPLICATIONS AND CLAIM TO PRIORITY

This application claims priority to U.S. Provisional Patent Application No. 60/565,288, filed on Apr. 26, 2004, and entitled “SYSTEM AND METHOD FOR MOBILE DEMAND RESET,” which is herein incorporated by reference in its entirety.

### FIELD OF THE INVENTION

The invention relates generally to radio frequency (RF) communication systems, and more particularly to RF communication architectures used in advanced automatic meter reading (AMR) systems utilizing mobile readers.

### BACKGROUND OF THE INVENTION

Automatic meter reading (AMR) systems are generally known in the art. Utility companies, for example, use AMR systems to read and monitor customer meters remotely, typically using radio frequency (RF) and other wireless communications. AMR systems are favored by utility companies and others who use them because they increase the efficiency and accuracy of collecting readings and managing customer billing. For example, utilizing an AMR system for the monthly reading of residential gas, electric, or water meters eliminates the need for a utility employee to physically enter each residence or business where a meter is located to transcribe a meter reading by hand.

There are two general ways in which current AMR systems are configured, fixed networks and mobile networks. In a fixed network, endpoint devices at meter locations communicate with readers that collect readings and data using RF communication. There may be multiple fixed intermediate readers, or relays, located throughout a larger geographic area on utility poles, for example, with each endpoint device associated with a particular reader and each reader in turn communicating with a central system. Other fixed systems utilize only one central reader with which all endpoint devices communicate. In a mobile network, a handheld unit or otherwise mobile reader with RF communication capabilities is used to collect data from endpoint devices as the mobile reader moves from place to place. The differences in how data is reported up through the system and the impact that has on number of units, data transmission collisions, frequency and bandwidth utilization has resulted in fixed network AMR systems having different communication architectures than mobile network AMR systems.

AMR systems can include one-way, one-and-a-half-way, or two-way communications capabilities. In a one-way system, an endpoint device typically uses a low power count down timer to periodically turn on, or “bubble up,” in order to send data to a receiver. One-and-a-half-way AMR systems include low power receivers in the endpoint devices that listen for a wake-up signal which then turns the endpoint device on for sending data to a receiver. Two-way systems enable two way command and control between the endpoint device and a receiver/transmitter. Because of the higher power requirements associated with two-way systems, two-way systems have not been favored for residential endpoint devices where the need for a long battery life is critical to the economics of periodically changing out batteries in these devices.

It would be desirable to provide for a mobile AMR system that had a communication architecture capable of efficiently supporting two way communications, while also permitting the flexibility of configuring the mobile AMR system to utilize different initiation protocols and to provide the capability of working in both a mobile network and a fixed network AMR system.

### SUMMARY OF THE INVENTION

The present invention is a system and method for collecting data generated by a plurality of metering devices located within a geographic area. The mobile automatic meter reading system provides two-way simplex communication capabilities between a mobile receiving device and a plurality of endpoint devices on a plurality of communication channels. The mobile collector device efficiently and accurately communicates with and receives data from the endpoint devices while moving throughout a localized geographical area. Aspects of the invention thereby improve the effectiveness of automatic meter reading systems.

In one embodiment, an automatic meter reading communication network for collecting data generated by a plurality of metering devices located within a geographic area comprises a plurality of fixed-location endpoint devices and at least one mobile receiving device adapted to selectively enter and exit the geographic area. Each endpoint device is coupled to a respective metering device and includes a low-power consumption wireless transceiver adapted to receive command and control signals on a control channel defined in a frequency band and to transmit data signals representative of at least a portion of the data generated by the metering device and signals representative of a state of the endpoint device on one of a plurality of data channels defined in the frequency band. The mobile receiving device includes a wireless transceiver adapted to transmit command and control signals on the control channel and receive data signals transmitted by the plurality of endpoint devices on the plurality of data channels. Unlike existing two-way AMR communication schemes, the control channel and the plurality of data channels are all simplex communication channels.

In another embodiment of the invention of an automatic meter reading communication network, a method for collecting data generated by a plurality of metering devices located within a geographic area comprises the steps of: providing each endpoint device with a low-power consumption wireless transceiver adapted to receive command and control signals on a control channel defined in a frequency band and to transmit data signals representative of at least a portion of the data generated by the metering device and signals representative of a state of the endpoint device on one of a plurality of data channels defined in the frequency band; causing at least one mobile receiving device having a wireless transceiver to selectively enter and exit the geographic area; while the at least one mobile receiving device is in the geographic area, transmitting command and control signals from the at least one mobile receiving device on the control channel and receiving data signals transmitted by the plurality of endpoint devices on the plurality of data channels, wherein the control channel and the plurality of data channels are simplex communication channels.

The above summary of the invention is not intended to describe each illustrated embodiment or every implementation of the invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is an exemplary diagram of an area in which one embodiment of the mobile AMR system of the invention may be implemented.

FIG. 2 is an exemplary diagram of an area in which one embodiment of the mobile AMR system of the invention may be implemented.

FIG. 3 is a flowchart of an architecture according to one embodiment of the invention.

FIG. 4 is a flowchart of the architecture of FIG. 3 according to one embodiment of the invention.

FIG. 5 is a flowchart of an architecture according to one embodiment of the invention.

FIG. 6 is a flowchart of an architecture according to one embodiment of the invention.

FIG. 7 is a flowchart of a switching process according to one embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

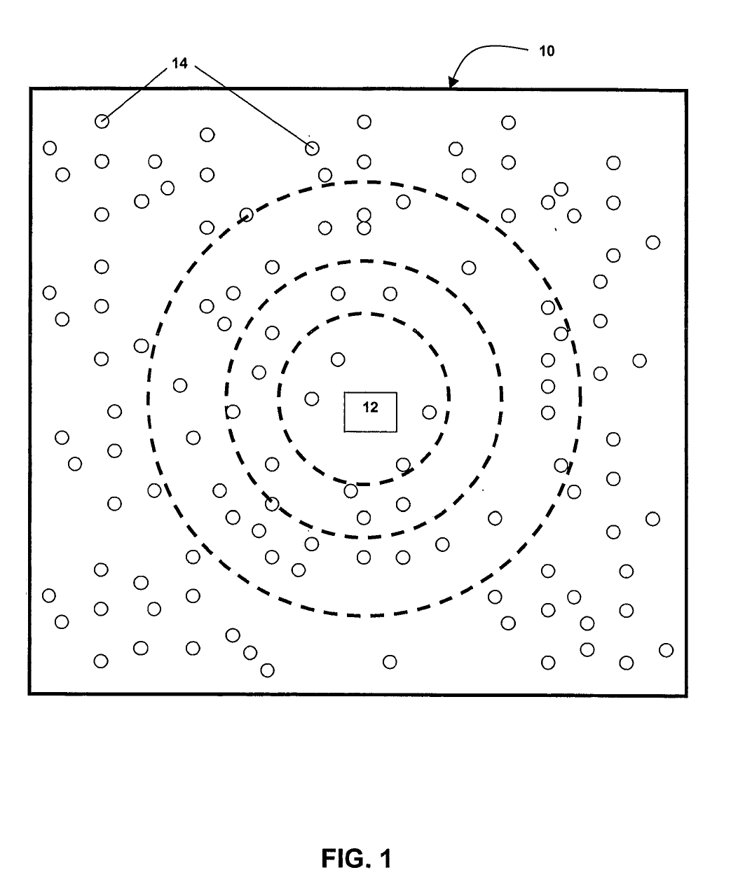

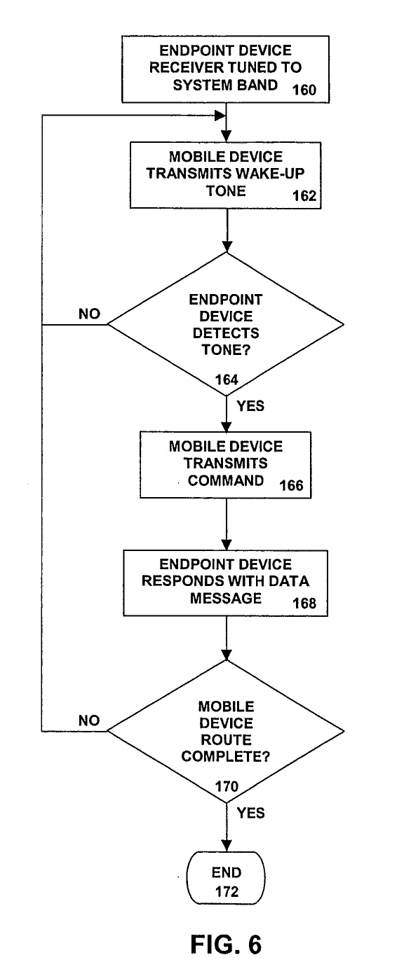

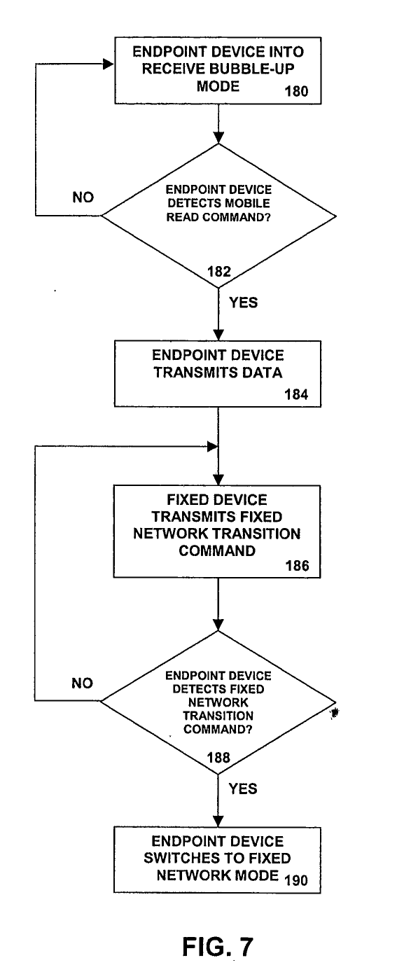

The mobile AMR system and method of the invention provide demand reset functionality and enable collection of interval or other large set data in a mobile environment. The invention can be more readily understood by reference to FIGS. 1-7 and the following description. While the invention is not necessarily limited to such an application, the invention will be better appreciated using a discussion of example embodiments in such a specific context.

Referring to FIG. 1, the system of the invention generally comprises a mobile receiving device 12 and a plurality of endpoint devices, or meters, 14. A metering device can be distinct from but coupled to endpoint device 14, or endpoint device 14 may be integrated into a metering device, wherein the metering device comprises a transceiver and related circuitry. Mobile receiving device 12 and endpoint devices 14 can communicate with each other in a variety of ways, dependent upon the system architecture being used. In one preferred embodiment, mobile device 12 and the plurality of endpoint devices 14 communicate using an RF communication scheme. Other wireless communication techniques can be used in other preferred embodiments of the invention and can vary according to an area or mode of system implementation, as will be appreciated and understood by those skilled in the art. The mobile or radio unit system is attractive because it does not need a more costly and complex fixed infrastructure as in other AMR systems. Utilities, telemetry, and other data collection companies can therefore more easily afford to implement such a system. The system is preferably hardware compatible with other AMR systems, including fixed network systems.

Mobile device 12 is preferably mounted in a vehicle, for example a utility company van that travels through a geographically dispersed system. Mobile device 12 and an associated antenna are therefore typically located approximately five to eight feet above the ground on the vehicle and will generally transmit and receive on particular communication channels, which are listed and described in more detail below. This will aid in minimizing interference from neighboring fixed network AMR system hubs if common channels exist and are in use in the same geographic area. In another embodiment, mobile device 12 is a portable handheld device that may or may not be vehicle-mounted for an entire route.

Mobile device 12 will typically transmit at more power than endpoint devices 14, for example about 30 dBm versus about 14 dBm, respectively; have its vehicle-mounted antenna higher in the air; and generally be free of obstructions. In one embodiment, European mobile devices 12 transmit at about 14 dBm. System and device customization for various global markets, including the U.S. and Europe, is described in more detail below. Endpoint devices 14 will preferably cause even further reduced co-channel interference with neighboring AMR systems because the power level and antenna height of endpoint devices 14 are typically lower.

The system of the invention is generally implemented in a localized geographical area 10, such as a municipality, subdivision, or other similar area. Preferred embodiments can have particular applicability in residential areas, as such areas will comprise zones of varied densities including, for example, single- and multi-family homes, apartment complexes, residential medical facilities, educational centers, and distributed areas of commercial zoning, all of which are areas similar to those in which fixed network AMR systems are currently implemented.

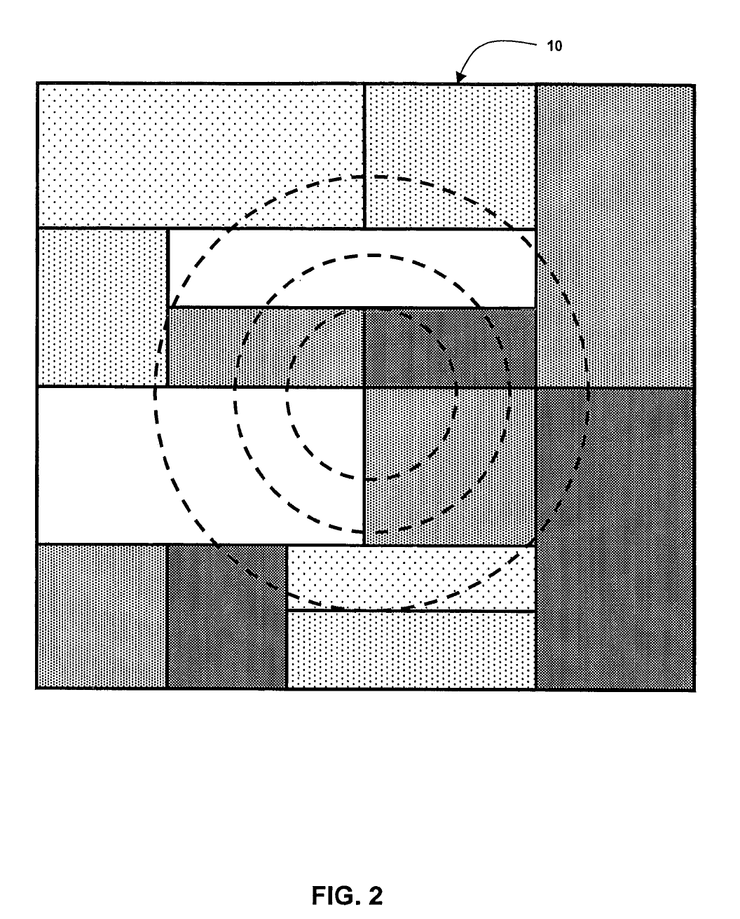

Varied area density, one example of which is illustrated in FIG. 2 by the different levels of shading, will affect the meter density and therefore the communications capabilities that will be required of the various devices that comprise the system. The varied densities of FIG. 2 are only exemplary and do not necessarily correspond to the distribution of endpoint devices 14 shown in FIG. 1.

An exemplary system and device communication analysis considering varied area density and useful in the implementation of preferred embodiments of the invention is included herein. Accordingly, one exemplary embodiment of the system can be implemented in an area 10 having an estimated density of one residential meter per approximately 33,508 square feet. This density can and will vary in other typical system implementations, as no two geographic areas are exactly the same, but serves here as a starting point in describing and analyzing only one representative example. TABLE 1 shows that at a range of about 1000 feet from mobile receiving device 12 in such an area 10, there can be as many as seventy-eight (78) meters to be read.

TABLE 1

| MOBILE RADIO | | | |
|---|---|---|---|
| UNIT TO | AH IN | AH IN | NUMBER OF |
| ENDPOINT | SQUARE FEET | SQUARE MILES | METERS/MOBILE RADIO |
| DEVICE IN FEET | (APPROX.) | (APPROX.) | UNIT/INSTANT |
| 100 | 25,980 | 0.0009 | 1 |
| 200 | 103,920 | 0.0037 | 3 |
| 400 | 415,680 | 0.0149 | 12 |
| 500 | 649,500 | 0.0233 | 19 |
| 800 | 1,662,720 | 0.0596 | 50 |
| 1000 | 2,598,000 | 0.0932 | 78 |
| 1200 | 3,741,120 | 0.1342 | 112 |
| 1500 | 5,845,500 | 0.2097 | 174 |
| 1800 | 8,417,520 | 0.3019 | 251 |
| 2000 | 10,392,000 | 0.3728 | 310 |
| 2500 | 16,237,500 | 0.5824 | 485 |
| 3000 | 23,382,000 | 0.8387 | 698 |

The system will also be customizable for and compatible in various world regions other than the United States/North America, including the European marketplace, which usually operates at lower power levels and less bandwidth. The system can also be customized to comply with local or regional communications standards and regulations. Accordingly, one embodiment of the system is optimized for use in North America, wherein a frequency band that the system uses in one embodiment in the United States is about 1427 MHz to about 1432 MHz. The frequency band is preferably broken into five sub-bands, each having a bandwidth of about 1.0 MHz. The approximate sub-bands in this exemplary U.S. embodiment are therefore as follows:
0: about 1427 MHz to about 1428 MHz
1: about 1428 MHz to about 1429 MHz
2: about 1429 MHz to about 1430 MHz
3: about 1430 MHz to about 1431 MHz
4: about 1431 MHz to about 1432 MHz

The above frequencies and frequency ranges, and other similar examples given herein throughout, are representative only of one preferred embodiment, which will be apparent from the contexts in which examples are given and embodiments described. Those skilled in the art will recognize that other embodiments can vary from these particular examples without departing from the invention.

In one embodiment, the two lower bands, 0 and 1, can be reserved for a Cell Control Unit (CCU) and other high-end communications used in fixed network systems that are compatible with the mobile system of the invention. This compatibility is advantageous in embodiments in which the mobile system of the invention is used to supplement a fixed network system in situations in which one or a group of endpoint devices 14 are misread or unread as part of the normal operation of the fixed network system. Frequencies are preferably offset by about 25 kHz to minimize interference that can occur because of overlaps in coverage with neighboring AMR systems. For example, in a given geographical area in which the system is implemented, multiple utility companies or other system users may exist and their respective systems may abut one another in some places. RF coverage between the neighboring systems may overlap in these places and cause interference.

Communication channels used in the system are preferably spaced about 200 kHz apart, with the first channel centered about 150 kHz above the band edge and proceeding in about 200 kHz steps. In one preferred embodiment, all channels are simplex communication channels, as opposed to known mobile AMR systems that generally use a more complex duplex mode of operation.

To ease set-up and implementation, endpoint devices 14 can be initially set on a control channel and programmed to then go into the appropriate mode at installation. Frequencies are shown in TABLE 2:

TABLE 2

| | FREQUENCY | APPROXIMATE |
|---|---|---|
| CHANNEL | NAME | FREQUENCY |
| 1 | 1 V | 14xx.150 |
| 2 | 2 V | 14xx.350 |
| 3 | 3 V | 14xx.550 |
| 4 | 4 V | 14xx.750 |
| 0 | Wake-up/Control | 14xx.950 |

To determine coverage and propagation of mobile device 12 in this exemplary embodiment, several RF communication factors are considered. In one embodiment, a sensitivity of mobile device 12 is about −110 dBm for 1% frame error rate and a sensitivity of endpoint device 14 is about −105 dBm for 1% frame error rate. In another embodiment in which an endpoint device 14 includes a tone detector to receive an initial wake-up signal from mobile device 12, a sensitivity of such an endpoint device 14 is about −100 dBm. A link margin is about 20 dB above sensitivity. Mobile device 12 preferably has a transmit power of about +30 dBm (1 W) or +14 dBm (25 mW) and an antenna gain of about 3 dBi, while endpoint device 14 has a transmit power of about +14 dBm (25 mW) and an antenna gain of about 0 dBi.

Path losses can be estimated according to the above as follows:
Mobile device 12 to endpoint device 14:

Path loss with 20 dB margin=+30+3−(−105)+0−20=118 dB
Mobile device 12 to endpoint device 14:

Path loss with 20 dB margin=+14+3−(−105)+0−20=102 dB
Mobile device 12 to super-regenerative receiver-equipped endpoint device 14:

Path loss with 20 dB margin=+30+3−(−100)+0−20=113 dB
Mobile device 12 to super-regenerative receiver-equipped endpoint device 14:

Path loss with 20 dB margin=+14+3−(−100)+0−20=97 dB
Endpoint device 14 to mobile device 12:

Path loss with 20 dB margin=+14+0−(−110)+3−20=107 dB

Different path loss equations can be used to estimate the path losses that may occur in various different environments in which the system may be implemented. Losses in a free space environment will also be estimated as a control. Each equation has a different breakpoint at which the loss changes from a free space loss to a higher exponent loss. The following is the loss equation and the estimated loss for the given distances shown at about 1430 MHz rounded to the nearest 0.1 dB in various environments:

path loss=(10*loss exp)*log(distance)+25−((10*loss exp)−20)*log(breakpoint)

TABLE 3

| | | | OBSTRUCTED | OBSTRUCTED |
|---|---|---|---|---|
| | FREE SPACE | URBAN AREA | IN FACTORIES | IN BUILDINGS |
| BREAKPOINT (FEET) | 1 | 300 | 100 | 30 |
| LOSS EXP. | 2 | 2.7 | 4 | 5.3 |
| DISTANCE (FEET) | PL | PL | PL | PL |
| 50 | 59.2 | 59.2 | 59.2 | 66.5 |
| 100 | 65.2 | 65.2 | 65.2 | 82.5 |
| 200 | 71.3 | 71.3 | 77.3 | 98.4 |
| 350 | 76.1 | 76.6 | 87.0 | 111.3 |
| 500 | 79.2 | 80.8 | 93.2 | 119.5 |
| 800 | 83.3 | 86.3 | 101.4 | 130.4 |
| 1000 | 85.2 | 88.9 | 105.2 | 135.5 |
| 1500 | 88.8 | 93.6 | 112.3 | 144.8 |
| 2000 | 91.3 | 97.0 | 117.3 | 151.4 |
| 2500 | 93.2 | 99.6 | 121.1 | 156.6 |
| 3000 | 94.8 | 101.8 | 124.3 | 160.8 |

The above path loss equation and TABLE 3 are meant to provide an exemplary basis from which to determine whether endpoint devices 14 in the coverage area of mobile device 12 are capable of communicating with mobile device 12. Because of additional factors not accounted for in this example analysis of one preferred embodiment of the system, however, the actual path loss can vary from that estimated above in other embodiments.

Observations can be made from TABLE 3 and from link margin calculations to provide an indication of from what distances mobile device 12 and endpoint devices 14 will be able to talk to each other. TABLE 4 below shows these approximate communication distances:

TABLE 4

| | | | OBSTRUCTED | OBSTRUCTED |
|---|---|---|---|---|
| | FREE SPACE | URBAN AREA | IN FACTORIES | IN BUILDINGS |
| BREAKPOINT IN FEET | 1 | 300 | 100 | 30 |
| LOSS EXPONENT | 2 | 2.7 | 4 | 5.3 |
| Distance for | 43,500 feet | 11,970 feet | 2,086 feet | 468 feet |
| 118 dB path loss | | | | |
| 30 dBm mobile device to | | | | |
| endpoint device | | | | |
| Distance for | 6,900 feet | 3,060 feet | 831 feet | 233 feet |
| 102 dB path loss | | | | |
| 14 dBm mobile device to | | | | |
| endpoint device | | | | |
| Distance for | 24,500 feet | 7,820 feet | 1,564 feet | 377 feet |
| 113 dB path loss | | | | |
| 30 dBm mobile device to | | | | |
| tone detector endpoint | | | | |
| device | | | | |
| Distance for | 3,880 feet | 2,000 feet | 623 feet | 188 feet |
| 97 dB path loss (regen) | | | | |
| 14 dBm mobile device to | | | | |
| tone detector endpoint | | | | |
| device | | | | |
| Distance for | 12,260 feet | 4,685 feet | 1,108 feet | 290 feet |
| 107 dB path loss | | | | |
| 14 dBm endpoint device to | | | | |
| mobile device | | | | |

For example, with a loss exponent of 4.0, mobile device 12 at about +30 dBm and about +14 dBm can communicate directly with approximately 96% of endpoint devices 14 within about 2100 feet and about 800 feet, respectively. Using the same loss exponent of 4.0, approximately 96% of endpoint devices 14 could talk back to mobile device 12 at a range of almost 1100 feet, and 78% at about 2100 feet. However, endpoint device 14 will only be able to talk back to mobile device at a range of about 1100 feet in one embodiment because of endpoint device 14 communication capabilities. Using the loss exponent of 4.0 and tone detector for a wake-up in an equipped endpoint device 14, mobile radio 12 ate each about +30 dBm and about +14 dBm could wake up endpoint devices 14 at about 1600 feet and about 600 feet, respectively.

Considering the above communication description, the system can comprise one of a multitude of different architectures. Three exemplary architectures are described below to further illustrate ways in which a mobile system according to the invention can be implemented. A general emphasis is placed on preserving battery operation, or reducing device current drain, and limiting system complexity in order to reduce the costs associated with implementing and maintaining the system. The analysis of each architecture and the numbers used in the examples are, again, merely exemplary and used only to illustrate the differences between the architectures in the context of particular examples.

### Endpoint Device Bubble-Up with Polling

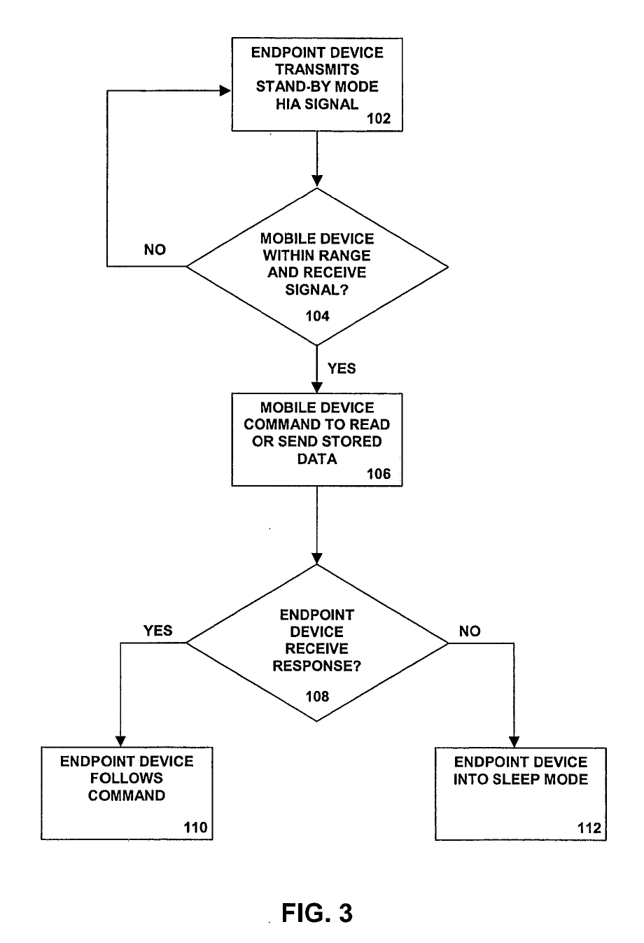

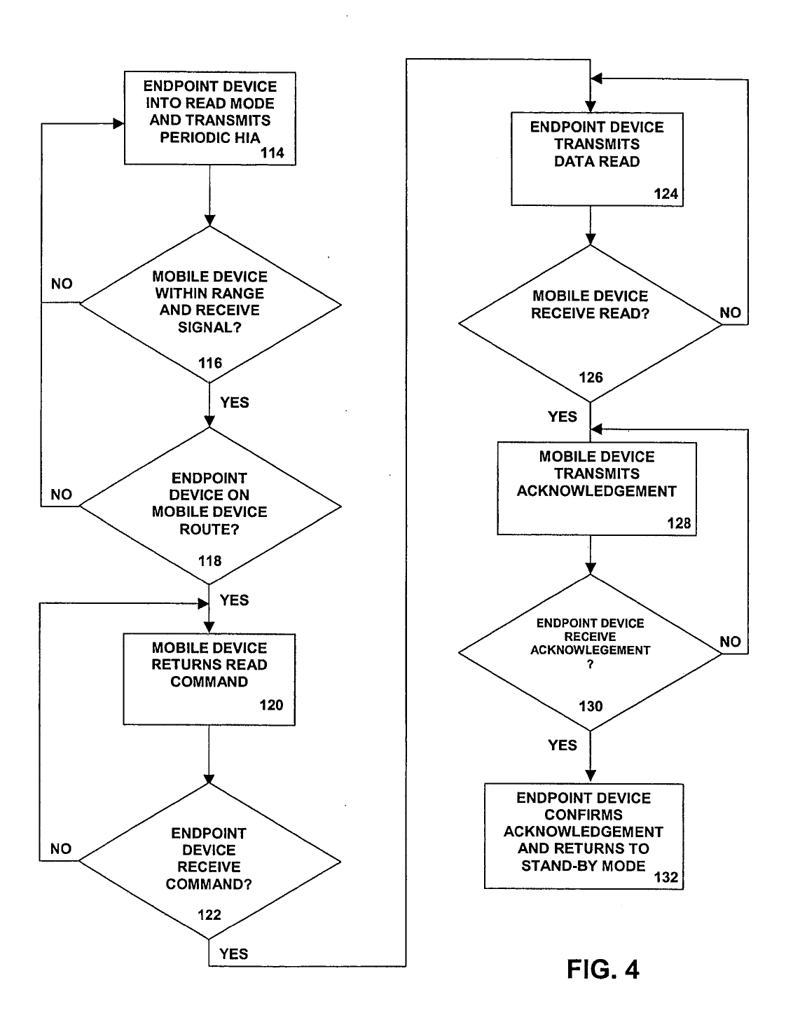

Referring to FIGS. 3 and 4, in a preferred embodiment of the endpoint device bubble-up with polling architecture, endpoint devices 14 are programmed to be in a stand-by mode for a period of days each month (FIG. 3) and in a read mode for the remainder of each month (FIG. 4). In one embodiment, endpoint devices 14 are in stand-by mode for twenty-five (25) days, followed by read mode for five (5) days. These numbers are only exemplary and may vary in other embodiments.

In stand-by mode at step 102, each endpoint device 14 on the route of mobile device 12 sends out a periodic “Here I Am” (HIA) in a pseudo-random time slot and on one of the four (4) available RF channels. In one embodiment, the HIA signal is a short two (2) millisecond (ms) burst of information sent every approximately fifteen (15) seconds, in order to conserve a power source of the endpoint device 14. At step 104, if mobile device 12, or a similar handheld unit in some embodiments, is within range, that unit will respond with a command to read or send stored data at step 106. Endpoint device 14 will listen for this return communication for, in one embodiment, about ten (10) ms at step 108. Endpoint device 14 will comply with the command at step 110 if endpoint device 14 receives the return communication. If endpoint device 14 does not hear a response from mobile device 12, endpoint device 14 will go into a low current sleep mode for some period of time, for example fifteen (15) seconds, to conserve energy at step 112. This process repeats for the stand-by period.

On the day following the end of the stand-by period, such as the twenty-sixth (26) day in an embodiment in which the stand-by period is twenty-five (25) days, a Real Time Clock (RTC) within endpoint device 14 switches device 14 into read mode at step 114. The same sequence as above is repeated except that device 14 now sends an HIA signal periodically, for example every approximately five (5) seconds in one preferred embodiment, to communicate to mobile device 12 that device 14 is ready to be read. At step 116, if the HIA is received by a mobile device 12 in the vicinity and if endpoint device 14 is on mobile device 12's route, mobile device 12 returns a read command to endpoint device 14 at step 120. If endpoint device 14 successfully receives the read command during a receive window at step 122, which is about ten (10) ms in one embodiment, endpoint device 14 sends out the data read at step 124. If mobile device 12 receives the data read at step 126, device 12 sends an acknowledgement back to endpoint device 14 at step 128. If endpoint device 14 receives the acknowledgement from mobile device 12 at step 130, endpoint device 14 confirms by sending an acknowledgement back to mobile device 12 at step 132. Endpoint device 14 will then return to stand-by mode until the next read cycle begins or according to an updated cycle received from mobile device 12 in the acknowledgement after receiving data.

In this and other preferred embodiments, mobile device 12 is capable of receiving HIA messages on each of four (4) receivers. If device 12 receives more than one HIA, device 12 will choose one and respond with the read polling command in transmit mode, and then store the identifications of the other endpoint devices 14 from which other HIAs were received. In this embodiment, mobile device 12 is not duplex and will transmit on only one frequency at a time, although this may vary in other embodiments.

### Mobile Device Wake-Up with Data Burst

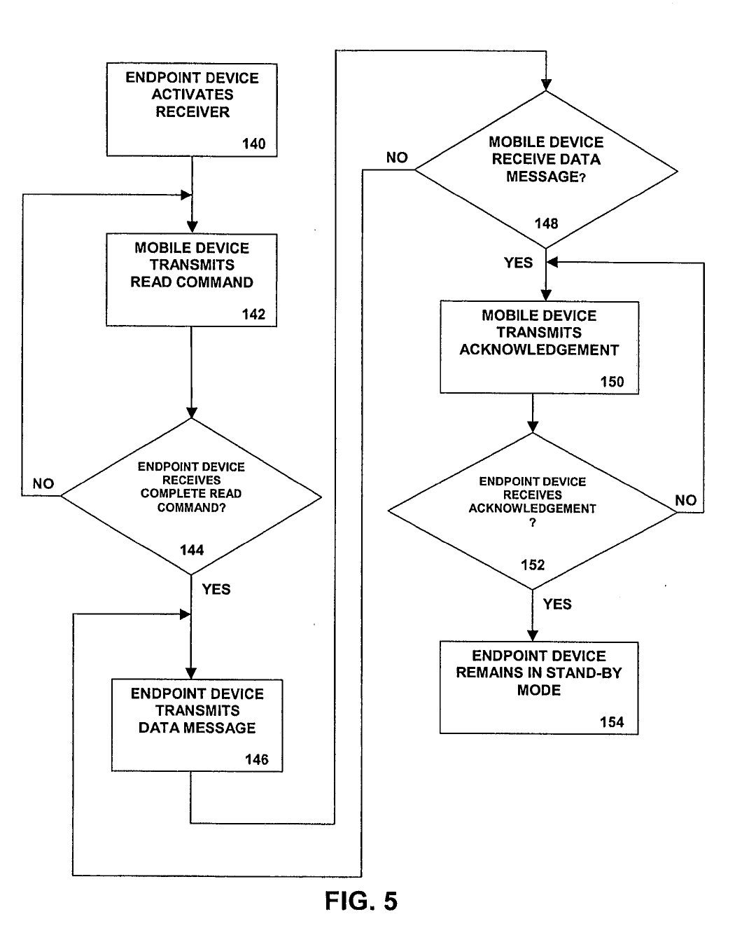

Referring to FIG. 5, in one preferred embodiment of a mobile device wake-up with data burst architecture, endpoint device 14 activates its receiver for about ten (10) ms every approximately five (5) seconds at step 140, although these time segments can vary in other embodiments. Mobile device 12 follows a route in area 10 and transmits a read command to all endpoint devices 14 within range at step 142. The read command can be approximately ten (10) ms long. Mobile device 12 then listens for a response from any device 14 for a predetermined amount of time, for example about ten (10) ms. This sequence can be continuously repeated.

If any endpoint device 14 hears any part of a read command from mobile device 12, device 14 remains on for the next complete transmission by mobile device 12. Upon correctly receiving and decoding the complete read command at step 144, endpoint device 14 transmits the ten (10) ms data message at step 146. Mobile device 12 will respond with an acknowledgement at step 150 after receiving the data message at step 148. The acknowledgement instructs endpoint device 14 to remain in stand-by mode, which occurs at step 154, and to not respond to any other read commands for a specified time period. If any other endpoint device 14 hears the acknowledgement at step 152, that device 14 will remain active for the next read command at step 154. Mobile device 12 read command can be directed toward a group of endpoint devices 14 or an individual device 14, depending upon the particular protocol in use.

Mobile device 12's transmitter is preferably one of the four (4) RF channels previously described. Because mobile device 12 is capable of receiving on all four (4) RF channels to hear endpoint devices 14 talking back, collisions and interference are reduced. Endpoint devices 14 receiving for about ten (10) ms every approximately five (5) seconds also provide a time variance among devices 14 within the system to reduce communicative collisions.

### Two-Step Wake-Up

One preferred embodiment of a two-step wake-up architecture is a combination of the previous two architectures and an additional mobile AMR system. In this embodiment, each endpoint device 14 comprises a super-regenerative receiver tuned to a particular band (step 160), such as the 1430 MHz band in one embodiment, and a fully channelized 1430 MHz transceiver FM radio. The transceiver is typically in sleep mode most of the time. At step 162, a mobile device 12 in range, for example driving by in the case of a vehicle-mounted device, transmits on one of the aforementioned RF frequencies, carrier modulated with an approximately 32.5 Hz square wave. The signal of mobile device 12 is an on-off-keyed (OOK) carrier that is “on” for about 15.385 ms and fully “off” for about 15.385 ms. During the “off” period, mobile device 12 has four (4) FM receivers monitoring the four (4) RF channels.

In this embodiment, endpoint devices 14 within range of mobile device 12 detect the 32.5 Hz tone and wake up the FM radios to receive a read command from mobile device 12 during device 12's on period at step 164. The read command transmitted at step 166 may be directed to an individual endpoint device 14 or a group of endpoint devices 14. Mobile device 12 preferably sends frequency shift keying (FSK) commands at about 9600 bps for up to the full 15.385 ms of the on period, for a maximum total of about eighteen (18) bytes of information. Endpoint device 14 responds to mobile device 12 at step 168 with a data message on one of the four (4) frequencies and in a pseudo-random mobile device 12 off time slot.

A minimum number of collisions occur because of the frequency and time diversity. Therefore, limits can be placed on the number of times the data messages are sent, for example one (1) to five (5) times, or a time between messages could be defined, for example about five (5), ten (10), or fifteen (15) seconds.

The previously described process then continues until mobile device 12's route is complete at steps 170 and 172. Data transfers between endpoint device 14 and mobile device 12 at about 38.4 kbps for about 15.385 ms yield approximately seventy-two (72) bytes of data/protocol. If more data remains to be sent, endpoint device 14 can use the next mobile device receive slot to send the data.

Each endpoint device 14 does not have to be on the same tone frequency as the other devices 14, and preferably is not, or the FM receivers would always be on, draining current and reducing power source life. If ten (10) different tones are used, one-tenth of the devices 14 could be allocated on each tone. Battery on-time of the FM transceiver would then be only one-tenth of what would otherwise be required.

Because endpoint devices 14 are operating in a very low current or super-regenerative mode during most of the monthly cycle, devices 14 will preferably achieve a power source life of ten or more years when the power source is an “A”-type battery cell. Alternatively, system simplicity and reduced cost could be sacrificed in exchange for adding an additional battery and extending the battery life further or using an alternate power source.

As previously described, each endpoint device 14 is preferably initially set on the control channel to transmit or “bubble up” every approximately fifteen (15) seconds for about two (2) ms with an HIA or go into regenerative mode in one embodiment. During an installation procedure, device 14 is initiated via communications with a handheld device after mounting and installing endpoint device 14. This handheld device transmits a data/command burst instructing endpoint device 14 to go into mobile device mode and provides other instructions including initialization parameters, reading cycle, frequency, and the like. Once completed, the handheld unit can read endpoint device 14 to verify that device 14 is operating properly.

There will be occasions when an endpoint device 14 will lose synchronization with the mobile radio device system. One way to regain synchronization includes endpoint device 14 going to the control channel if device 14 has not received communication from mobile device 12 or a handheld device for a predefined number of days. Alternatively, endpoint device 14 could go into the factory programmed transmit bubble up mode approximately every fifteen (15) seconds for about two (2) ms on the control channel or the regenerative mode. Mobile device 12 or a handheld device can hear this during a read sequence and command lost endpoint device 14 to go to one of the four (4) RF channels and operate in the mobile radio device system.

### Switching Between a Fixed Network System and a Mobile System

In certain applications, it will be desired or required for one or more endpoint devices 14 to be compatible with and operate in both a fixed network system and a mobile system. Therefore, a switching mechanism can be included in endpoint devices 14 in one preferred embodiment to provide device compatibility with both system architectures.

A first switching mechanism can be implemented in an endpoint device 14 that is typically part of a fixed network AMR system. A switching mechanism would therefore enable compatibility with both fixed and mobile system architectures by instructing endpoint device 14 to go into receive bubble-up mode every approximately fifteen (15) seconds at step 180 to listen for a handheld unit or mobile device 12. Upon detection of a handheld unit or mobile device RF carrier read command at step 182, endpoint device 14 could send out data at step 184. If endpoint device 14 is operating in the regenerative mode previously described, device 14 can wake up upon receiving the proper tone, turn on the FM receiver, receive the read command during mobile device 12's “on” cycle, and then send back the data during mobile device 12's “off” cycle.

To then go from mobile system mode to fixed network mode, a central fixed network device sends out an OOK signal with a FSK signal riding with the on portion of the carrier in one preferred embodiment of the switching mechanism at step 186. The FSK signal can contain a group or individual command to endpoint device(s) 14 to go into the correct fixed network system. If endpoint device 14 uses the super-regenerative receiver, the central fixed network device would send out the OOK signal with the appropriate tone to wake up the FM receivers in endpoint device(s) 14. Once on, the FM receivers would detect the command to switch to fixed network mode at step 188 and endpoint device(s) 14 would be appropriately switched at step 190.

Data packet sizes will influence the timing and battery power considerations and calculations in the system, as will be appreciated by those skilled in the art. In one preferred embodiment, the first data packet transmitted will be the HIA from an endpoint device 14 to mobile device 12. In one exemplary embodiment, a HIA packet can be ten (10) bytes long and sent at about 38.4 kbps, which will take about 2.083 ms to transmit. The HIA packet will preferably comprise two (2) bytes of bit sync, two (2) bytes of frame sync, four (4) bytes of endpoint device identification, and two (2) bytes of CRC16 (a 16-bit cyclic redundancy check), although other packets can also be used.

The second data packet is preferably a mobile device 12 to endpoint device 14 read command, which is about twelve (12) bytes long sent at about 9600 bps and will take about ten (10) ms to transmit in one embodiment. The packet will preferably comprise two (2) bytes of bit sync, two (2) bytes of frame sync, four (4) bytes of endpoint device identification to read, two (2) bytes of command/parameters, and two (2) bytes of CRC16 in one embodiment.

The third data packet in the sequence is preferably the data packet from endpoint device 14 to mobile device 12. The third packet is preferably forty-eight (48) bytes long, which when sent at about 38.4 kbps will take about ten (10) ms. The packet will preferably comprise two (2) bytes of bit sync, two (2) bytes of frame sync, four (4) bytes of endpoint device identification, thirty-eight (38) bytes of data, and two (2) bytes of CRC16 in one embodiment.

The bandwidth of the modulated signal is a function of several factors, including the data rate, encoding technique, deviation, data wave shape generation, and base-band filtering, as can be appreciated by those skilled in the art. Endpoint device 14 to mobile device 12 communications will preferably use FSK modulation with about 38.4 kbps Manchester encoded data in one embodiment of the invention. Deviation is expected to be about ±40 kHz in this exemplary embodiment.

Accordingly, and using Carson's rule, the approximate bandwidth for endpoint device 14 to mobile device 12 communications is as follows:

BW=2*Peak Deviation+2*Base-band bandwidth

BW=2*40 kHz+2*38.4 kHz

BW=156.8 kHz

Mobile device 12 to endpoint device 14 communications will preferably use FSK modulation with about 9.6 kbps Manchester encoded data in one embodiment. Here also, deviation is expected to be about ±40 kHz. Using Carson's rule, the approximate bandwidth is as follows:

BW=2*Peak Deviation+2*Base-band bandwidth

BW=2*40 kHz+2*9.6 kHz

BW=99.2 kHz

Endpoint device 14's RTC is preferably running at all times, even during endpoint device 14's sleep time. The RTC and a counter in a microcontroller of endpoint device 14 instruct the receiver when to turn on. Since the RTC is preferably relatively low frequency to keep the sleep mode current low, thereby reducing current consumption and prolonging power source life, an approximately 32 kHz crystal will be used in one embodiment. In the monthly read cycle of the system, an endpoint device 14 will be about 388.8 seconds, slightly less than seven minutes, off from real time with a stability of about −150 ppm. When compared to a 24-hour time slot, this deviation is negligible. To compensate for the deviation and maintain system synchronization, however, mobile device 12 can send a message correcting the endpoint device 14 RTC during the monthly read in one preferred embodiment.

A second correction scheme that can be used in another preferred embodiment and that would be compatible with fixed network systems as previously described is a frequency-locked loop (FLL) between the RF reference crystal and the 32 kHz timing crystal. Each transmit/receive low current sequence provides a compare of the two frequencies and uses the output to set a new divide ratio in the microcontroller of the 32 kHz crystal in this embodiment. Since the reference crystal is preferably about ±25 ppm in the worst case, the RTC would be set close thereto.

As previously stated, reducing power consumption is a concern in the system of the invention in order to keep costs, particularly those related to maintenance, low. The following calculations are exemplary of battery power consumption issues considered in the design and implementation of preferred embodiments of the system. To clarify, some of the currents not considered in this exemplary analysis are the initial synchronization, actual read of the meters or sensors, transmitter charge pump, battery leakage, battery aging, falsing, and endpoint device(s) 14 present in multiple utility configurations. The two modes examined here are the endpoint device bubble-up with polling and mobile device wake-up with data burst as described in more detail above.

Assumptions made in the following calculations include the following:
Transmit current drain is about forty-eight (48) mA with an exemplary chip;
Receive current drain is about twelve (12) mA with the exemplary chip;
Sleep mode current drain is about 3.5 uA with the exemplary chip;
The mobile device cycle is five (5) days in “read” mode and twenty-five (25) days in “stand-by” mode;
The transmit HIA burst is about two (2) ms;
The receive times are about ten (10) ms;
The time for receive start up is about two (2) ms and will have receive mode current;
The time for transmit start up is about two (2) ms and will have receive mode current;
Endpoint devices 14 transmit every approximately fifteen (15) seconds in bubble-up stand-by mode and approximately five (5) seconds in read mode;
Endpoint devices 14 receive every approximately five (5) seconds in the mobile device 12 wake-up mode;
Transmit data current for mobile device wake-up with data burst and two step is assumed negligible because it preferably occurs only once per month;
Receive data current for two step is assumed negligible because it preferably occurs only once per month; and
Receive regenerative current for two step is about six (6) mA if a buffer is used in one preferred embodiment.

Exemplary calculations for endpoint device bubble-up with polling in one preferred embodiment are as follows:

Stand-by transmit (start)=0.002 sec/15 sec*12 mA*25/30=1.333 uA

Stand-by transmit=0.002 sec/15 sec*48 mA*25/30=5.333 uA

Stand-by receive=0.012 sec/15 sec*12 mA*25/30=8.000 uA

Read transmit (start)=0.002 sec/5 sec*12 mA*5/30=0.800 uA

Read transmit=0.002 sec/5 sec*48 mA*5/30=3.200 uA

Read receive=0.012 sec/5 sec*12 mA*5/30=3.840 uA

Sleep (assuming 30 days for this example)=3.500 uA

TOTAL average current (approximate)=26.006 uA

According to an exemplary battery lifetime curve, this results in a battery life of about eight (8) years with one “A” battery and approximately sixteen (16) years with a “C” battery in this exemplary calculation related to one preferred embodiment. Other timings and system characteristics, as can be appreciated by those skilled in the art, will result in different battery lifetimes. It is also observed that transmit/receive currents could be reduced considerably if the two (2) ms start-up time for each mode is at a lower current.

Exemplary calculations for mobile radio unit wake-up with data burst in one preferred embodiment:

Read receive=0.012 sec/5 sec*12 mA=28.800 uA

Read transmit=negligible for 1 read/month=0.000 uA

Sleep (assume all 30 days for ease)=3.500 uA

TOTAL average current (approximate)=32.300 uA

According to the battery lifetime curve, this will result in a lifetime of seven (7) years with one “A” battery and sixteen (16) years with a “C” battery.

Exemplary calculations for two-step wake-up in one preferred embodiment:

Sleep (assuming thirty days for these calculations)=3.500 uA

Read transmit/receive=negligible for one read per month=0.000 uA

Receive regenerative current=6.000 uA

TOTAL average current=9.500 uA

According to the battery lifetime curves, this results in a lifetime of about twenty-two (22) years with one “A” battery in the above described embodiment.

The invention therefore substantially meets the aforementioned needs of the industry, in particular by providing a system and method of data collection and communication within an AMR system that are optimized for mobile read rates, eliminating the need to physically visit a remote endpoint device and connect directly to the endpoint device for the collection of data.

In one preferred embodiment, the invention comprises a mobile AMR system and method for communicating with a plurality of endpoint meter devices. The mobile AMR system provides two-way communication capabilities between a mobile radio collector device and a plurality of endpoint meter devices. The mobile collector device efficiently and accurately communicates with and receives data from the endpoint devices while moving throughout a localized geographical area.

In a related embodiment, system endpoint devices can communicate within more than one meter reading system. For example, a particular endpoint device may generally operate within a fixed network meter reading system while remaining capable of communicating with a mobile collector device of the system of the invention for supplementary or follow-up readings.

Preferred embodiments of the system and method of present invention therefore provide for more accurate and efficient meter reads and communications. The system and method of the invention also reduce costs by improving battery life in system devices and reducing the need for an employee to personally read and maintain system devices.

The invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

1-13. (canceled)

14. An endpoint device for an automatic meter reading (AMR) system, comprising:
a metering interface circuit that obtains utility consumption information via a utility meter;
a transmitter circuit operably coupled to the utility meter interface circuit and adapted to transmit a message based on the utility consumption information;
a first receiver circuit and a second receiver circuit, each of the first receiver circuit and second receiver circuit operably coupled to the utility meter interface circuit; and to the transmitter circuit;
wherein the first receiver circuit is constructed to receive a specific communication initiation signal in a predefined communications band and to operate using relatively less power;
wherein the second receiver circuit is constructed to receive digital communications in the predefined communications band and to operate using relatively more power; and
wherein the endpoint device is configured to operate the second receiver circuit in response to the first receiver circuit receiving a signal indicative of a communication transmitted for reception by the endpoint.

15. The endpoint device of claim 14, wherein the second receiver circuit includes a channelized FM radio receiver circuit.

16. The endpoint device of claim 14, wherein the first receiver circuit includes a regenerative receiver circuit.

17. The endpoint device of claim 16, wherein the first receiver circuit includes a super-regenerative receiver circuit.

18. The endpoint device of claim 14, wherein the specific communication initiation signal includes a wakeup tone having a predefined frequency.

19. The endpoint device of claim 14, wherein when the first receiver circuit is operating to listen for the specific wakeup signal, the second receiver circuit is kept inactive to conserve power.

20. A method for operating an endpoint device in an automatic meter reading (AMR) system, the method comprising:
automatically obtaining utility consumption information via a utility meter;
automatically operating a first receiver circuit to receive a specific communication initiation signal in a predefined communications using relatively less power; and
in response to the first receiver circuit receiving a signal indicative of a communication transmitted for reception by the endpoint, automatically operating a second receiver circuit to receive digital communications in the predefined communications band using relatively more power.

21. The method of claim 20, wherein operating the second receiver circuit includes operating a channelized FM radio receiver circuit.

22. The method of claim 20, wherein operating the first receiver circuit includes operating a regenerative receiver circuit.

23. The method of claim 22, wherein operating the first receiver circuit includes operating a super-regenerative receiver circuit.

24. The method of claim 20, wherein operating the first receiver circuit to receive a specific communication initiation signal includes receiving a wakeup tone having a predefined frequency.

25. The method of claim 20, further comprising:
keeping the second receiver circuit inactive to conserve power when the first receiver circuit is operating to listen for the specific wakeup signal.
